(19) United States
(12) Patent Application Publication
(10) Pub. No.: US 2008/0143226 A1
(43) Pub. Date: Jun. 19, 2008

(54) SLIDE RAIL

(75) Inventors: KUO-MING HUANG, Tu-Cheng (TW); MO-MING YU, Shenzhen (CN); HAI-CHEN ZHOU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/947,774

(22) Filed: Nov. 30, 2007

(30) Foreign Application Priority Data
Dec. 14, 2006 (CN) 200610201301.6

(51) Int. Cl. A47B 88/04; B60N 2/075

(52) U.S. Cl. 312/334.8; 248/429

(57) ABSTRACT

A slide rail includes a first slide and a second slide. The first slide provides a first arced surface. The second slide provides a second arced surface for being engaged with the first arced surface, so that the second slide is slidable relative to the first slide. The second arced surface has a same curvature as that of the first arced surface.

### BACKGROUND

1. Field of the Invention

The present invention generally relates to slide rails. Particularly, the present invention relates to slide rails without ball bearings.

2. Description of related art

Slide rails are used for guiding objects, such as drawers, to be pushed into or pulled out from bodies, such as furniture. There are many kinds of slide rails, some have ball bearings and others do not. Slide rails having ball bearings are easy to be pulled or pushed, for they have little friction. However, the ball bearings add to the cost of the slide rails, and brackets for supporting the ball bearings tend to be broken, which causes the slide rail to become unusable.

Slide rails without ball bearings have lower costs than those having ball bearings. Such slide rails each has at least two slides movable relative to each other. The two slides contact each other in a line-contact mode. This kind of contact makes the slide rails unable to support heavy loads.

Therefore, a need exists in the industry to provide a low-cost slide rail which can support heavy loads.

### SUMMARY

In one embodiment, a slide rail includes a first slide and a second slide. The first slide provides a first arced surface. The second slide provides a second arced surface for being engaged with the first arced surface, so that the second slide is slidable relative to the first slide. The second arced surface has a same curvature as that of the first arced surface.

Other advantages and novel features of the slide rail will become more apparent from the following detailed description of preferred embodiments when taken in conjunction with the accompanying drawings, in which:

### BRIEF DESCRIPTION OF THE DRAWINGS

FIG. 1 is a perspective view of a slide rail in accordance with an exemplary embodiment of the present invention;

FIG. 2 is an assembled view of the slide rail of FIG. 1; and

FIG. 3 is a cross-sectional view of the slide rail of FIG. 2.

### DETAILED DESCRIPTION

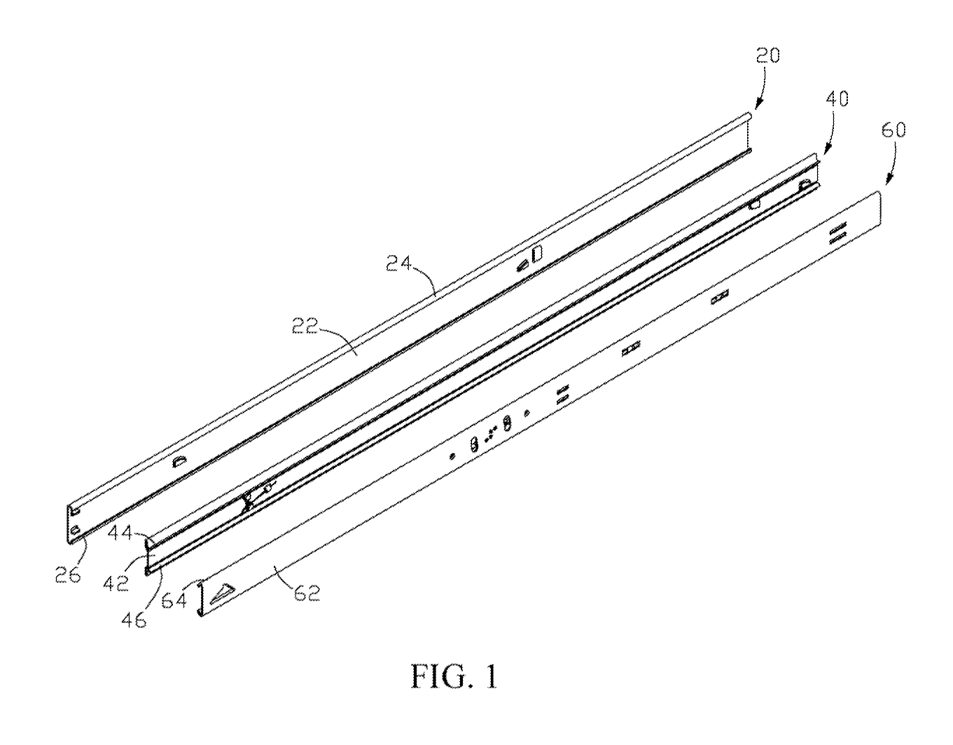

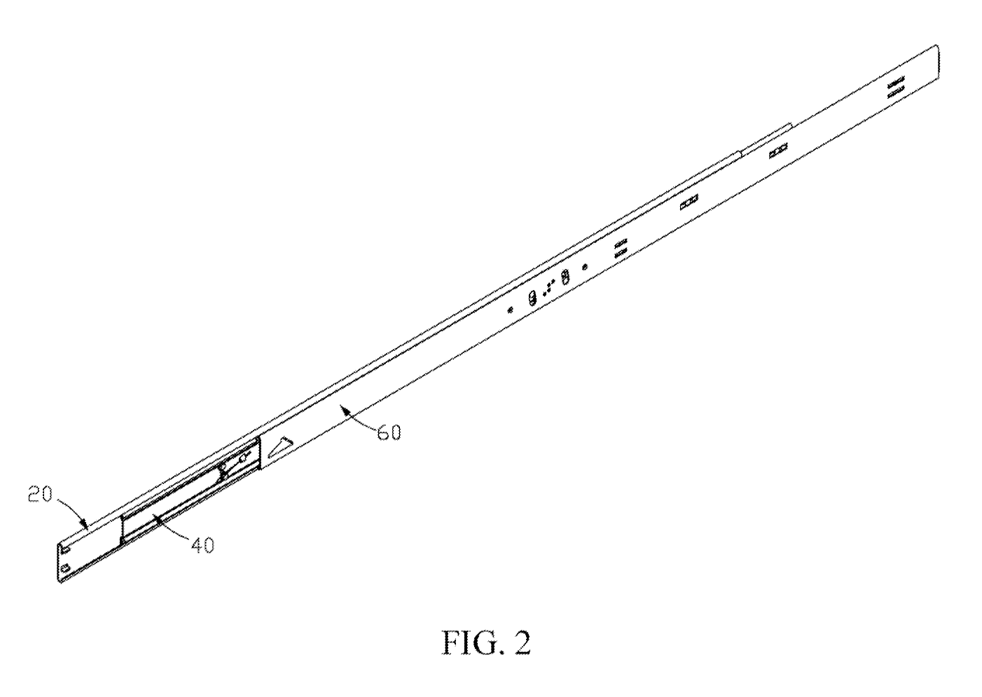

Referring to FIG. 1 and FIG. 2, a slide rail in accordance with an exemplary embodiment includes a first slide 20, a second slide 40, and a third slide 60. The first slide 20 is used for being fixed on a stable object, like a kind of furniture, or racks for servers. The third slide 60 can be fixed on a movable object, such as drawers of the furniture, or servers to be installed in the racks. The second slide 40 is received in the first slide 20, and installed between the first slide 20 and the third slide 60. The second slide 40 is movable relative to the first slide 20 and the third slide 60. Through the motion between the three slides, the movable object can be pushed into or pulled out from the stable object.

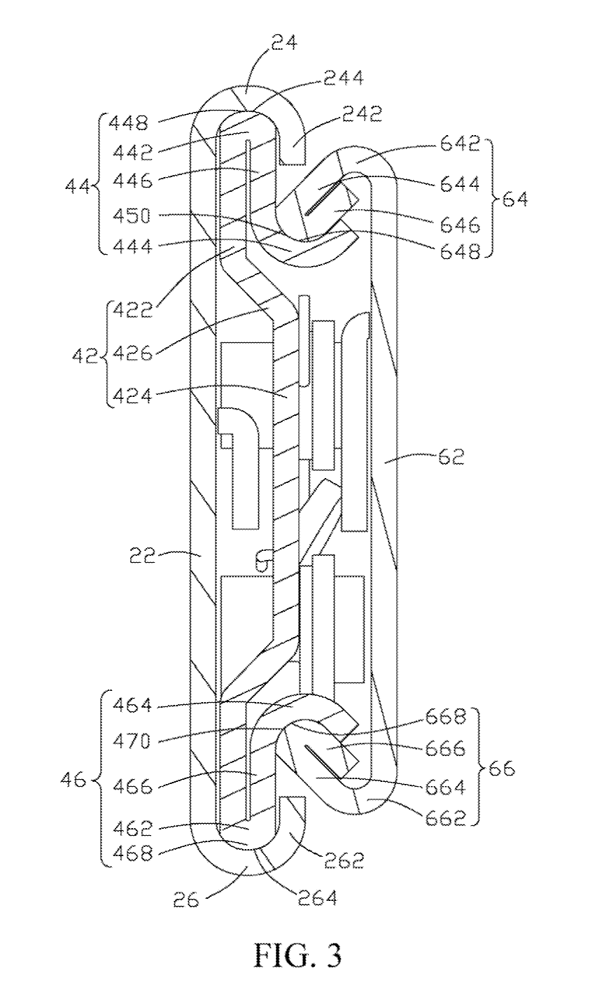

Referring to FIG. 3, the first slide 20 includes a bottom wall 22 and a pair of sidewalls 24, 26. The bottom wall 22 extends in the longitudinal direction, along with the sidewalls 24 and 26. The two sidewalls 24 and 26 are extended from the bottom wall 22 at its two longitudinal sides, in an identical direction. Ends 242 and 262 of the two sidewalls 24 and 26 are respectively turned over to be generally parallel with the bottom wall 22. At an inner side of each of the sidewalls 24 and 26, first recesses 244, 264 are provided respectively.

The second slide 40 includes a main plate 42 and two side parts 44, 46. The two side parts 44 and 46 are symmetrically disposed on two sides of the main plate 42, integrally extending from the main plate 42.

The main plate 42 includes a pair of end portions 422, a flat panel 424, and a pair of connection portions 426. The end portions 422 are disposed on two side of the flat panel 424, and are parallel with the flat panel 424, which is parallel with the bottom wall 22 of the first slide 20 after assembled. The connection portions 426 connect the pair of end portions 422 and the flat panel 424 at two sides of the flat panel 424, respectively. The connection portions 426 are symmetrically inclined to the flat panel 424. After assembly, the end portions 422 are nearer the bottom wall 22 than the flat panel 424.

The side parts 44 and 46 have generally the same structure, so the side part 46 is mainly described in below description for simplicity. The side part 46 includes a first curve 462, a second curve 464, and a connection portion 466. The first curve 462 is extended from the end portion 422 of the main plate 42. The first curve 462 interconnects the end portion 422 and the connection portion 466, which is parallel with the end portion 422. A first camber 468 is provided on an outer surface of the first curve 462. The curvature of the first camber 468 is the same as the curvature of the first recess 264 of the first slide 20. The connection portion 466 is generally extended from the first curve 462 in a direction approaching the inclined connection portion 426 of the main plate 42. The second curve 464 extends from the connection portion 466 in a direction away from the connection portion 426 of the main plate 42. Accordingly, a second recess 470 is provided in an inner surface of the second curve 464.

Similarly, the side part 44 includes a first curve 442, a second curve 444, and a connection portion 446. The connection portion 446 interconnects the first curve 442 and the second curve 444. The first curve 442 provides a first camber 448 on the outer surface thereof, and the second curve 444 provides a second recess 450 on the inner surface thereof.

The third slide 60 includes an installation plate 62 and two arms 64, 66 symmetrically disposed on two sides of the installation plate 62 respectively. The installation plate 62 can be fixed to the movable object when in use, and is parallel with the bottom wall 22 of the first slide 20 after assembly. The arms 64 and 66 that have symmetrically the same structures are used for clamping the second slide 40 when assembled.

The arm 64 includes a bending portion 642, a clamp plate 644, and a free end 646. The bending portion 642 interconnects the installation plate 62 and the clamp plate 644. The bending portion 642 is set in such a manner that, the end of the clamp plate 644 other than its opposite end that is connected to the bending portion 642, points at the second curve 444, and is received in the second curve 444. The bending portion 642 guides the installation plate 62 to turn over from its edge to its central part.

The end of the clamp plate 644, other than its opposite end that is connected to the bending portion 642, turns around to form the free end 646. The free end 646 is generally parallel with the clamp plate 644. At a cross that the clamp plate 644 meets the free end 646, a second camber 648 is provided. The second camber 648 has a same curvature as that of the second recess 450.

Similarly, the arm 66 includes a bending portion 662, a clamp plate 664, and a free end 666. A second camber 668 is also provided at the cross that the clamp plate 664 meets the free end 666.

In assembly, the second slide 40 is received in the first slide 20, with the first cambers 448, 468 slidably engaging with the first recesses 244, 264, respectively. Thus, the second slide 40 and the first slide 20 contact each other at arced surfaces thereof. The third slide 60 is slidably sleeved over the second curves 444, 464 of the second slide 40, with the second cambers 648, 668 engaging with the second recesses 450, 470, respectively. Accordingly, the second slide 40 and the third slide 60 contact each other at arced surfaces thereof in other than in line-contact mode.

Some lubricant can be added on the contact surfaces of the slides, which can result in smooth movement during pushing and pulling of the slides, and facilitates use of the slide rail.

The slides of the slide rail contact each other at arced surfaces, which reduces the intensity of pressure applied on the slides. Accordingly, the slide rail is able to endure heavy loads. The arced contact surfaces can also be utilized in slide rails having only two slides, or four or more slides, as well.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A slide rail comprising:
a first slide providing a first arced surface; and
a second slide providing a second arced surface for being engaged with the first arced surface so that the second slide is slidable relative to the first slide, wherein the second arced surface has a same curvature as that of the first arced surface.

2. The slide rail as described in claim 1, wherein the first arced surface and the second arced surface are provided on two sides of the first slide and the second slide, respectively.

3. The slide rail as described in claim 1, wherein the first slide comprises a bottom wall and two sidewalls symmetrically extending from two sides of the bottom wall, the two sidewalls provide the first arc surfaces on its inner side.

4. The slide rail as described in claim 3, wherein the two sidewalls are extended from the two sides of the bottom wall to turn over to a direction parallel with the bottom wall.

5. The slide rail as described in claim 3, wherein the second slide comprises a main plate and two side parts symmetrically extending from two sides of the main plate respectively, the two side parts provide the second arced surfaces on its outer side.

6. The slide rail as described in claim 5, wherein the main plate comprises a flat panel and a pair of end portions that are disposed on two sides of the flat panel, the end portions being parallel with the flat panel.

7. The slide rail as described in claim 6, wherein the end portions are connected to the two sides of the flat panel through a pair of inclined connection portions.

8. The slide rail as described in claim 6, wherein each of the two side parts comprises a first curve, which is connected to the end portions, the first curve providing the second arced surface.

9. The slide rail as described in claim 1, further comprising a third slide, the third slide provides a third arced surface for being engaged with a fourth arced surface provided by the second slide, so that the third slide is slidable relative to the second slide.

10. The slide rail as described in claim 9, wherein the second slide comprises a main plate and two side parts symmetrically extending from two sides of the main plate respectively, the two side parts comprising:
a first curve providing the second arced surface on its outer side;
a second curve providing the fourth arced surface on its inner side; and
a connection portion connecting the first curve and the second curve.

11. The slide rail as described in claim 9, wherein the third arced surface has a same curvature as that of the fourth arced surface.

12. The slide rail as described in claim 9, wherein the third slide comprising two arms respectively providing the third arced surfaces on its outer side.
